(19) United States
(12) Patent Application Publication
(10) Pub. No.: US 2018/0189865 A1
(43) Pub. Date: Jul. 5, 2018

(54) SYSTEMS, METHODS, AND COMPUTER-READABLE MEDIA FOR CONDUCTING AN ONLINE AUCTION USING NARROWING UPPER AND LOWER BOUNDS

(71) Applicant: Microsoft Technology Licensing, LLC, Redmond, WA (US)

(72) Inventors: Eric Glen WEYL, New York, NY (US); David Myer PENNOCK, Princeton, NJ (US); Siddhartha SEN, New York, NY (US); Eduardo Monteiro de AZEVEDO, New York, NY (US)

(73) Assignee: Microsoft Technology Licensing, LLC, Redmond, WA (US)

(21) Appl. No.: 15/398,041

(22) Filed: Jan. 4, 2017

(51) Int. Cl. G06Q 30/08

(52) U.S. Cl. CPC G06Q 30/08

(57) ABSTRACT

An online auction that combines elements of traditional English-style (ascending price) and Dutch-style (descending price) online auction is disclosed. Such an online auction maintains simultaneous ascending lower-bound price(s) and descending upper-bounds price(s) that gradually converge, narrowing the channel between them. The auction may be for a single, many identical, or several different objects or services and ends when supply equates to demand at either the upper or lower bound prices. The rate of adjustment of each price or set of prices is determined partly in response to the demand conditions at the other price and partly with the goal of achieving rapid convergence towards an equilibrium price where supply equals demand. This online auction design combines the information revealed by an English-style online auction with the safety and planning allowed to participants in a Dutch-style online auction.

### TECHNICAL FIELD

Embodiments of the present disclosure relate generally to the field of e-commerce. More specifically, embodiments of the present disclosure relate to conducting an online auction using narrowing upper and lower bounds.

### INTRODUCTION

Online sellers of goods or services have a goal to obtain the highest price for his or her goods, and online buyers of the goods or services wish to obtain the goods or services at the lowest price. Online auctions provide a way of selling goods or services where the price of the goods or services is based on competition among multiple buyers. Thus, online auctions provide a way for a market of the goods or services to determine prices for the goods or services.

There are many different types of online auctions that are available for use on the Internet. In an English-style online auction, the auction starts at an initial low price. Online bids are gradually accumulated from bidders, and successively higher bids are accumulated from the bidders until the increase in bid prices stops. The goods or services are then sold to the highest bidder. English-style online auctions may have the advantage that bidders have an incentive to remain in the online auction until his or her maximum value (i.e., his or her maximum willingness-to-pay) is reached. If the bidder know the maximum value, and other bidders observe the points at which their rival bidders drop out, the auction may potentially reveal information about the market value of the object or service sold. One drawback of the English-style auction, however, is that bidders have no guarantee about the final price he or she may have to pay, and thus, it may be a risk for bidders to participate in the online auction. It may also be easy for bidders to collude in an English-style auction, as a strong bidder may deter other bidders from participating without having to pay a high price himself or herself by announcing he or she is willing to pay up to a very high price. Further, English-style online auctions may take a relatively long time to finish because of small increments in bid price collected over time.

In a Dutch-style online auction, the auction starts at an initial high price. The initial high price may be progressively lowered until a buyer claims the goods or services. A clock may be used to progressively lower the price. When multiple goods or services are being auctioned, the price may continue to decrease until all of the goods or services are claimed. The Dutch-style online auction may allow a seller to obtain a better perceived price for his or her goods or services, especially by making bidder collusion challenging. It may also provide bidders with the confidence to learn about or invest in the objects or services being sold because the descending price provides a guarantee about a maximum price. However, the Dutch-style auction may force bidders to guess about the price at which others will enter the auction, which may provide less information about other bidders' behavior and which may provide no indication as to how low the auction price may fall. Thus, the Dutch-style auction may make it hard for bidders to know if it is necessary for them to investigate a purchase carefully.

Each of these types of online auction has advantages and disadvantages. English-style auctions may reveal more information as bidders see the points at which rival bidders drop out of the online auction and may provide information about how low the price of the object or service in the auction may be. Dutch-style auctions may allow bidders to guarantee a maximum price he or she may have to pay, and thus, may allow for better planning. However, there exists a need to provide an online auction type that provides the benefits of both auction types while also allowing for a relatively fast-paced auction.

### SUMMARY OF THE DISCLOSURE

According to certain embodiments, systems, methods, and computer-readable media are disclosed for conducting an online auction using narrowing upper and lower bounds.

According to certain embodiments, computer-implemented methods for conducting an online auction using narrowing upper and lower bounds are disclosed. One method includes: receiving, over an electronic communications network at an auction server, information relating to at least one of an object or a service to be sold in an online auction, the information including an initial high value; setting, by the auction server, an ascending auction value to an initial low value; setting, by the auction server, a descending auction value to the initial high value; iteratively performing, by the auction server, the following steps: determining, by the auction server, whether at least one bidder accepts the decreasing auction value; receiving, by the auction server no bidder accepts the decreasing auction value, an indication that the bidder accepts the ascending auction value; determining, by the auction server, whether more than one bidder of the plurality of bidders accepts the ascending auction value; and when more than one bidder accepts the ascending auction value and when no bidder accept the descending auction value, increasing the ascending auction value or decreasing the descending auction value.

According to certain embodiments, systems for conducting an online auction using narrowing upper and lower bounds are disclosed. One system includes: a data storage device that stores instructions for conducting an online auction using narrowing upper and lower bounds; and a processor configured to execute the instructions to perform a method including: receiving, over an electronic communications network, information relating to at least one of an object or a service to be sold in an online auction, the information including an initial high value; setting an ascending auction value to an initial low value; setting a descending auction value to the initial high value; iteratively performing the following steps: determining whether at least one bidder accepts the decreasing auction value; receiving, when no bidder accepts the decreasing auction value, an indication that the bidder accepts the ascending auction value; determining whether more than one bidder of the plurality of bidders accepts the ascending auction value; and when more than one bidder accepts the ascending auction value and when no bidder accepts the descending auction value, increasing the ascending auction value or decreasing the descending auction value.

According to certain embodiments, non-transitory computer-readable media storing instructions that, when executed by a computer, cause the computer to perform a method for conducting an online auction using narrowing upper and lower bounds are disclosed. One method includes: receiving, over an electronic communications network, information relating to at least one of an object or a service to be sold in an online auction, the information including an initial high value; setting an ascending auction value to an initial low value; setting a descending auction value to the initial high value; iteratively performing the following steps: determining whether at least one bidder accepts the decreasing auction value; receiving, when no bidder accepts decreasing auction value, an indication that the bidder accepts the ascending auction value; determining whether more than one bidder of the plurality of bidders accepts the ascending auction value; and when more than one bidder accepts the ascending auction value and when no bidder accepts the descending auction value, increasing the ascending auction value or decreasing the descending auction value.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 depicts and exemplary embodiment for an online auction using narrowing upper and lower bounds, according to embodiments of the present disclosure;

FIG. 2 depicts an exemplary graph of a gradual rate of adjustment of the ascending auction value and descending auction value, according to embodiments of the present disclosure;

FIG. 3 depicts an exemplary graph discrete adjustment of the ascending auction value and descending auction value, according to embodiments of the present disclosure;

FIG. 4 depicts an exemplary graph of multiple objects or services for sale with gradual adjustments of price, according to embodiments of the present disclosure;

FIG. 5 depicts a flowchart illustrating a method for conducting an online auction using narrowing upper and lower bounds, according to embodiments of the present disclosure;

FIG. 6 depicts a flowchart illustrating a method for narrowing upper and lower bounds, according to embodiments of the present disclosure; and

FIG. 7 is a simplified functional block diagram of a computer that may be configured as a device for executing the methods of FIGS. 5 and 6, according to exemplary embodiments of the present disclosure.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF THE EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having,” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.”

For the sake of brevity, conventional techniques related to systems and servers used to conduct online auctions and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

The present disclosure relates to conducting an online auction using narrowing upper and lower bounds. In one embodiment of the present disclosure, the online auction may be for a single object or service that is available for sale to a plurality of bidders. For the online auction, there may be two counters. One counter may begin at an initial low value, which may begin at zero (0) and/or a predetermined low price. The predetermined low price may be automatically determined by a comparison of the object or service for sale to previously sold, similar objects or services. In an alternative embodiment, a seller may set the predetermined low price. In another alternative embodiment, the predetermined low price may be a reserve price, which is a minimum price the object or service may be sold for, or a previous low price, which is an initial low price for a previously sold, similar object or service.

The other counter may an initial high value, which may begin at infinity and/or a predetermined high price. The predetermined high price may be automatically determined by a comparison of the object or service for sale to previously sold, similar objects or services. In an alternative embodiment, a seller may set the predetermined high price. In another alternative embodiment, the predetermined high price may be a previous high price, which is an initial high price for a previously sold, similar object or service.

The first counter may be referred to as an ascending auction value and the second counter may be referred to as a descending auction value. The difference or gap between the ascending auction value and the descending auction value may be referred to as a channel. At any point in time, all bidders must indicate whether they are willing to purchase the object or service at the ascending auction value. In other words, each bidder may indicate whether they accept the ascending auction value, and thus, the bidder wishes to continue participating in the online auction. If a bidder indicates that he or she accepts the ascending auction value, the bidder may purchase the object or service at the descending auction value, as long as the online auction has not ended. If the bidder indicates that he or she does not accept the ascending auction value, he or she may not participate in the online auction any further. If at some point the bidder is left as the only bidder participating at the ascending auction value, he or she must purchase at the ascending auction value. In other words, the bidder may have the ability to purchase the object or service at the descending auction value and/or the obligation to purchase the object or service at the ascending auction value.

The online auction may proceed by gradually increasing the ascending auction value and/or gradually decreasing the descending auction value, which may narrow the gap/channel between the ascending auction value and the descending auction value. The online auction may proceed until a winning bidder is determined when one of two conditions is met. One winning condition may occur when at any time during the online auction a bidder of the plurality of bidders accepts the descending auction value. Thus, the online auction may terminate, and the winning bidder may be awarded the object or service in exchange for the descending auction value. A second winning condition may occur when at any time during the online auction only one bidder remains in the online auction at the ascending auction value. Thus, the online auction may terminate, and the winning bidder may be awarded the object or service in exchange for the ascending auction value.

In alternative embodiments of the present disclosure, there may be other terminating conditions for the online auction. For example, a plurality of bidders may simultaneously accept the descending auction value, all remaining bidders may not accept the ascending auction value, or the ascending auction value and descending auction value may intersect without any bidders claiming the descending auction value and multiple bidders accepting the ascending auction value. In each of these alternative embodiments, the object or service may be randomly allocated to one of the relevant bidders at a prevailing relevant price.

As discussed above, the online auction may proceed by gradually increasing the ascending auction value and/or gradually decreasing the descending auction value, which may narrow the gap/channel between the ascending auction value and the descending auction value. The increasing of the ascending auction value and/or the decreasing of the descending auction value may occur by a variety of different methods.

In one embodiment of the present disclosure, the ascending auction value and/or the descending auction value may adjust at a gradual rate of adjustment. In one embodiment, the gradual rate of adjustment may be that the ascending auction value increases by a predetermined increasing price at a first predetermined amount of time and/or the descending auction value decrease by a predetermined decreasing price at a second predetermined amount of time. For example, the gradual rate of adjustment for the ascending auction value may be to increase by one dollar each second and the gradual rate of adjustment for the descending auction value may be to decrease by two dollars each second.

In another embodiment of the present disclosure, the gradual rate of adjustment may be that the ascending auction value increases by a predetermined increasing percentage at a first predetermined amount of time and/or the descending auction value decrease by a predetermined decreasing percentage at a second predetermined amount of time. For example, the gradual rate of adjustment for the ascending auction value may be to increase the ascending auction value by one percent (1%) each second and the gradual rate of adjustment for the descending auction value may be to decrease the descending auction value by two percent (2%) each second. When the gradual rate of adjustment for the ascending auction value or the descending auction value is a percentage, then the ascending auction value may not be initially set to zero and/or the descending auction value may not be initially set to infinity. In one embodiment, the ascending auction value and the descending auction value may be initially set to values that may be expected to converge at an expected final value.

In another embodiment of the present disclosure, the rate of adjustment may be that the ascending auction value increases and/or the descending auction value decrease based on a number of bidders that continue to accept the current ascending auction value. In other words, the rate of adjustment of the descending auction value may increase as the number of bidders decreases. For example, the descending auction value may decrease by a dollar or a percentage for each potential bidder that does not accept the ascending auction value (i.e., for each bidder who drops out of the online auction). Further, the ascending auction value may increase at a slower rate of adjustment in response to bidders dropping out of the online auction (i.e., for each bidder who does not accept the ascending auction value).

In another embodiment of the present disclosure, the ascending auction value and/or the descending auction value may adjust discretely (i.e., in jumps to speed the closure of the auction). In one embodiment, an intermediate value that is between the current ascending auction value and the current descending auction value may be used. The intermediate value may be provided to the plurality of bidders, and the plurality of bidders may be asked whether they accept the intermediate value. If a plurality of bidders accepts the intermediate value, the ascending auction value is set to the intermediate value. If no bidders accept the intermediate value, then the descending auction value is set to the intermediate value. If one bidder of the plurality of bidders accepts the intermediate value, the one bidder is allocated the good or service at the intermediate value. While a plurality of bidders remains in the online auction, another intermediate value that is between the current ascending auction value and descending auction value may be used, and the method may proceed until only one bidder remains.

In one embodiment, the intermediate value, which is between the current ascending auction value and the current descending auction value, may be chosen as (i) a value half way between the current ascending auction value and the current descending auction value; (ii) a geometric mean or other mathematical intermediate point of the current ascending auction value and current descending auction value; (iii) based on a number of bidders that accept the ascending auction value; or (iv) based on combination of the above-mentioned methods.

In the above-described embodiments, an object or service was for sale in an online auction. Presented in the exemplary embodiments below are online auctions in which multiple identical objects or services are for sale. In one embodiment, a uniform price may be used for the multiple identical objects or services. In another embodiment, personalized prices may be used for each of the multiple identical objects or services.

In the uniform price embodiment, the method may proceed in a manner similar to the embodiments in which a single object or service is sold. The first difference may be that a bidder who accepts the descending auction value is immediately assigned the object or service for sale, but the final value of the object or service for the bidder is not set. In other words, the bidder who accepts the descending auction value may pay the final price at the end of the auction, not the descending auction price. The second difference may be how the online auction terminates. The online auction may terminate with the descending auction value being the final price when the number of bidders accepting the descending auction value equals the total number of goods or services sold. The online auction may terminate with the ascending auction value being the final price when the number of bidders accepting the ascending auction value equals the total number of goods or services sold. When multiple similar objects or services are sold, a bidder may bid on more than one object or service at the descending auction value or ascending auction value. However, the number of objects or services available at the ascending auction price must be (i) greater than the number of bidders accepting the ascending auction value, and (ii) less than the number of bidders accepting the descending auction value.

In the personalized price embodiment, the online auction may proceed in the same manner as the uniform price embodiment except that a bidder who accepts the descending auction value pays the descending auction value as the final price even though some objects or services may remain unsold. Further, for each object or service accepted at the descending auction value, the bidder may have to withdraw one bid at the ascending price so that the total number of objects or services he or she may be able to win does not increase.

In both the uniform price embodiment and the personalized price embodiment, the rate of adjustment of the ascending auction value or descending auction value may be one or more of the methods discussed above. In addition to the methods discussed above, the rate of adjustment of the ascending auction value may also be based on a number of bidders that accept the descending auction value. The rate of adjustment of the descending auction value may also be based on the number of bidders that accept the descending auction value.

Presented in the exemplary embodiments below are online auctions in which multiple different objects or services are for sale. For each object or service for sale that is different, both an ascending auction value and a descending auction value is set and adjusted. The ascending auction values may gradually increase, but not necessarily in unison. The descending auction values may gradually decrease, but not necessarily in unison. Whenever an object or service is accepted at the descending auction value, the object or service may be removed from the online auction. The online auction may not terminate until either (i) all of the objects or services are sold at a final price, or (ii) the number of bidders that accept the ascending auction value equals the number of objects or services available. In other words, the online auction terminates for all remaining objects or services simultaneously, rather than separately across all objects and services.

The rate of adjustment for online auctions in which multiple different objects or services are for sale may be more similar to those in the single object or service online auction or multiple identical objects or services online auctions. In one embodiment, the rate of adjustment for each object or service may be based on the demand for the other objects and services.

According to the above-described embodiments, rather than a single ascending English-style online auction or a descending Dutch-style online auction, a hybrid online auction may be conducted. In such an online auction, both a lower-bound English-style price and an upper-bound Dutch-style price may be maintained at any point in time. The upper-bound price descends and the lower-bound price ascends so that gradually these two narrow towards the price at which the market will clear the object or service being auctioned. By combining the advantages of both the English-style and Dutch-style auction and by allowing a careful choice of the relative rates at which the above-described prices adjust, the hybrid online auction may allow for the discovery of the market clearing price more quickly, with a more appropriate allocation and yielding more value to the seller than previous online auctions.

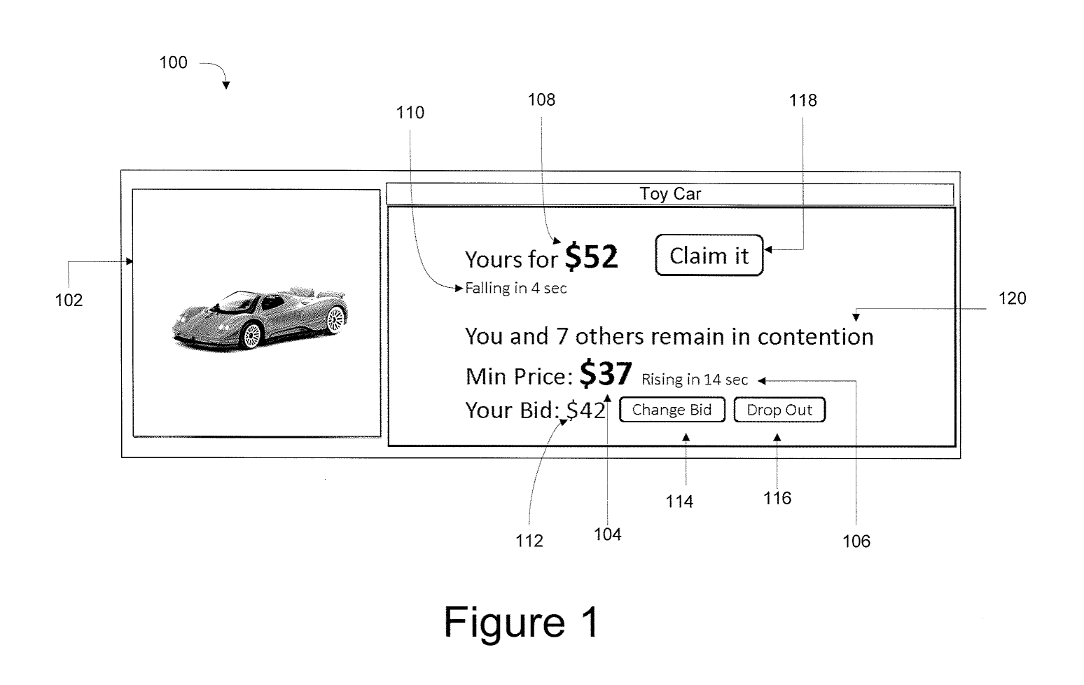

FIG. 1 depicts and exemplary embodiment for an online auction using narrowing upper and lower bounds, according to embodiments of the present disclosure. As shown in FIG. 1, the online auction 100 includes an object 102 that is for sale. The online auction includes a current ascending auction value 104, an ascending time indicator 106, a current descending auction value 108, a descending time indicator 110, a maximum acceptance value 112 for a bidder of a future ascending auction value, an acceptance value change button 114 to change the acceptance value 112 for the bidder, a drop out button 116 for the bidder to drop out of the online auction 100, a claim button 118 to claim the object 112 at the current descending auction value 108, and a number of bidders indicator 120.

In the exemplary embodiment shown in FIG. 1, a bidder in the online auction 100 for the object 102 has set his or her maximum acceptance value 112 for the object as $42. The current ascending auction value 104 is $37, with the bidder and seven (7) other rival bidders all currently accepting the current auction value 104 for the object 102. The current ascending auction value 104 will increase in fourteen (14) seconds, as indicated by the ascending time indicator 106. The bidder may change his or her maximum acceptance value 112 by clicking on the acceptance value change button 114, or he or she may drop out of the online auction 100 by clicking on the drop out button 116. If the bidder desires to claim the object 102, the bidder may click on the claim button 118 to pay the current descending auction value 108, which is $52. If the bidder clicks on the claim button 118, the online auction 100 may end. The descending time indicator 110 indicates that the current descending auction value 108 of $52 will decrease in four (4) seconds.

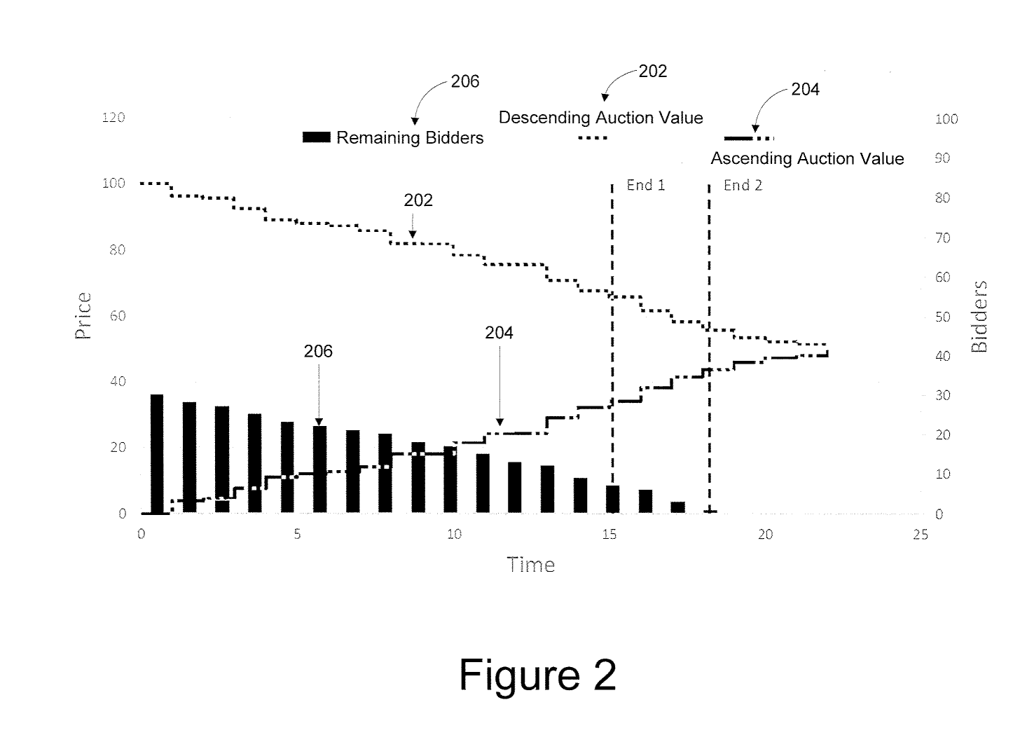

FIG. 2 depicts an exemplary graph of a gradual rate of adjustment of the ascending auction value and descending auction value, according to embodiments of the present disclosure. As shown in FIG. 2, the x-axis may represent a time of the online auction. The left y-axis may represent a price of the object or service of the online auction, and the right y-axis may represent a number of bidders participating in the online auction. The small dashed line 202 may be the descending auction value, the small and large dashed line 204 may be the ascending auction value, and the bars 206 may be the number of bidders who remain in the online auction.

As depicted in FIG. 2, the online auction progresses through time from the left side of the graph to the right side of the graph. In the online auction, the ascending auction value increases over time, the descending auction value decreases over time, and the gap/channel between the ascending auction value and the descending auction value decreases. As the ascending auction value increase, the number of bidders may decrease as the bidders drop out of the action.

As shown in FIG. 2, there are two points in time in which the online auction may end with the object or service for sale being sold to a bidder. The online auction may terminate at any time when a bidder claims the object or service at the descending auction value, as indicated by the End 1 dashed line. The online auction may also terminate when all but one bidder drop out (i.e., one bidder remains), in which case the last remaining bidder claims the object or service at the ascending auction value, as indicated by the End 2 dashed line. In the case where no bidders remain and no bidders claim at the descending auction value, the object or service may be awarded randomly to a bidder at the value in which the descending auction value and the ascending auction value meet, or the object or service may not be awarded.

FIG. 2 depicts a case in which the rate of adjustment of the ascending auction value and the descending auction value may be done at a gradual rate of adjustment. At regular intervals, the ascending auction value increases and the descending auction value decreases. In FIG. 2, the channel/gap between the ascending auction value and the descending auction value may close gradually, and may take a linear amount of time to close the channel/gap.

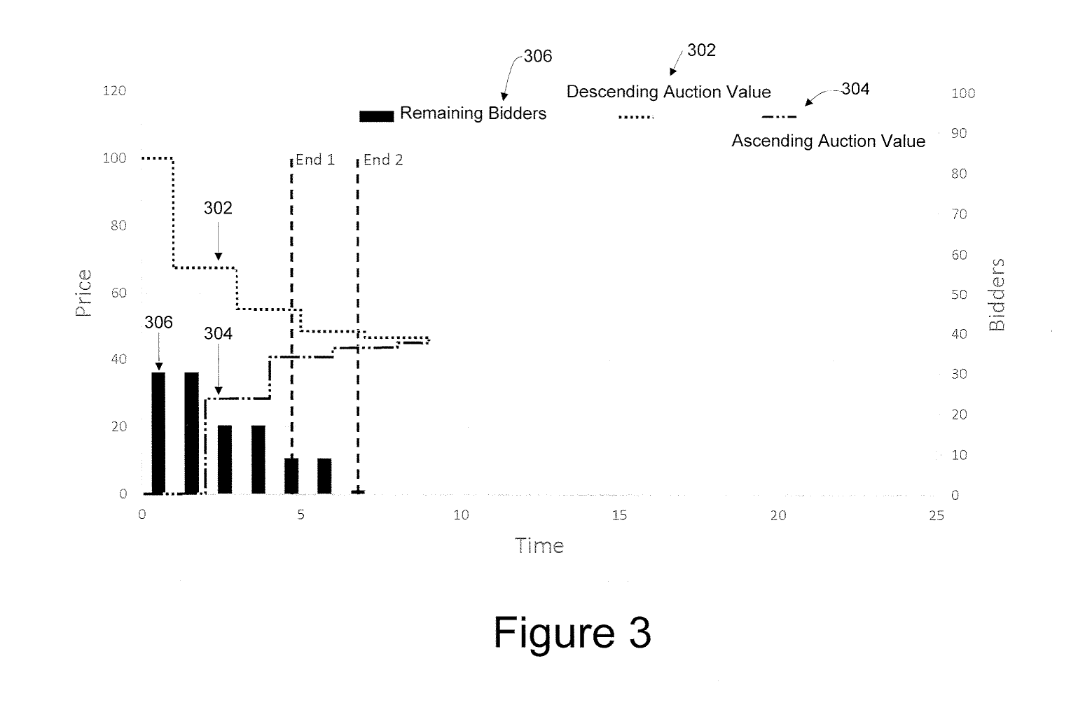

FIG. 3 depicts an exemplary graph of discrete adjustment of the ascending auction value and descending auction value, according to embodiments of the present disclosure. As shown in FIG. 3, the x-axis may represent a time of the online auction. The left y-axis may represent a price of the object or service of the online auction, and the right y-axis may represent a number of bidders participating in the online auction. The small dashed line 302 may be the descending auction value, the small and large dashed line 304 may be the ascending auction value, and the bars 306 may be the number of bidders who remain in the online auction.

As depicted in FIG. 3, the online auction progresses through time from the left side of the graph to the right side of the graph. In the online auction, the ascending auction value increases over time, the descending auction value decreases over time, and the gap/channel between the ascending auction value and the descending auction value decreases. As the ascending auction value increase, the number of bidders may decrease as the bidders drop out of the action.

As shown in FIG. 3, there are two points in time in which the online auction may end with the object or service for sale being sold to a bidder. The online auction may terminate at any time when a bidder claims the object or service at the descending auction value, as indicated by the End 1 dashed line. The online auction may also terminate when all but one bidder drop out (i.e., one bidder remains), in which case the last remaining bidder claims the object or service at the ascending auction value, as indicated by the End 2 dashed line. In the case where no bidders remain and no bidders claim at the descending auction value, the object or service may be awarded randomly to a bidder at the value in which the descending auction value and the ascending auction value meet, or the object or service may not be awarded.

FIG. 3 depicts a case in which adjustment of the ascending auction value and the descending auction value may be discrete. As shown in FIG. 3, the adjustment of the ascending and descending auction values may occur by choosing an intermediate value between the current descending auction value and the current ascending auction value. At each intermediate value, either there is more than a single bidder demanding the object or service, in which case the intermediate value becomes the new ascending auction value, or no one demands the object or service, in which case the intermediate value becomes the new descending auction value. Thus, the ascending auction value increases and the descending auction value decreases discretely. The values of the ascending auction value and the descending auction value may jump in large or small values, according to the methods described above. A benefit of the use of the discrete adjustment is that the online auction may terminate relatively faster than when gradual adjustment is used. This termination may occur at a point like that marked “End 2,” when exactly one bidder demands the object or service at the ascending auction value, and the object or service is awarded to the bidder at the ascending auction value. Another way the online auction may terminate is that after an increase in the ascending auction value, some of the bidders may decide to purchase at the descending auction value, as marked at “End 1.”

FIG. 3 depicts a case in which the rate of adjustment of the ascending auction value and the descending auction value may be done discretely. In FIG. 3, the channel/gap between the ascending auction value and the descending auction value may take a logarithmic amount of time to close because of the use of a binary search to adjust the ascending auction value and the descending auction value.

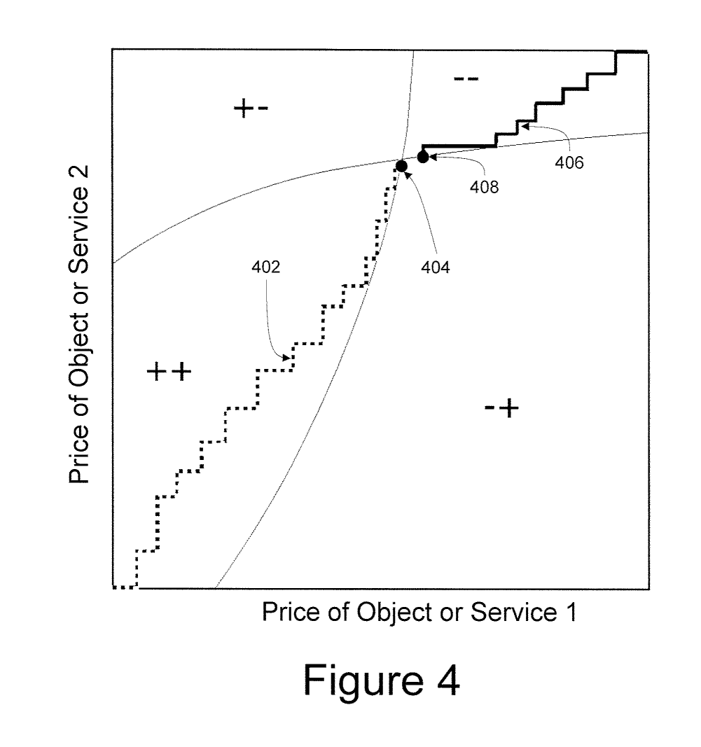

FIG. 4 depicts an exemplary graph of multiple objects or services for sale with gradual adjustments of price, according to embodiments of the present disclosure. As shown in FIG. 3, the x-axis may represent a price of a first object or service of an online auction. The y-axis may represent a price of a second object or service of the online auction. The small dashed line 302 may be the descending auction value, the small and large dashed line 304 may be the ascending auction value, and the bars 306 may be the number of bidders who remain in the online auction.

In this exemplary embodiment, the initial ascending auction values may start at zero (0,0), which may be interpreted as a price of 0 for object or service 1 and a price of 0 for object or service 2. The initial descending auction values may be a very high value for the object or service 1 and the object or service 2.

The dashed line 402 may represent a path of the ascending auction values through the online auction. The ascending auction values may begin at (0, 0), and gradually increase, with the ascending auction values being at the solid dot 404 at the termination of the online auction. The solid line 406 may represent a path of descending auction values through the online auction. The descending auction values may gradually drop during the online auction. As mentioned above, the descending auction values may begin at a very high value, and the descending auction values may end at the solid dot 408.

As shown in FIG. 4, regions may be depicted with labels ++, −+, +−, and −−. The ++ region may be where there is excess demand for both object or service 1 and object or service 2. In other words, at the current ascending auction values for both object or service 1 and object or service 2, the number of available objects or services demanded by bidders is greater than the number available objects or services. Similarly, the −− region may where there is excess supply of both object or service 1 and object or service 2. The +− region may be where there is excess demand of object or service 1, but excess supply of object or service 2. The −+ region may be where there is excess supply of object or service 1, but excess demand of object or service 2. As shown in FIG. 4, the online auction gradually adjusts the ascending auction values and the descending auction values of both objects or services until a final point where supply and demand are balanced. The online auction does so in a manner that maintains excess demand for both goods or services at the lower bound and excess supply on both goods or services at the upper bound prices.

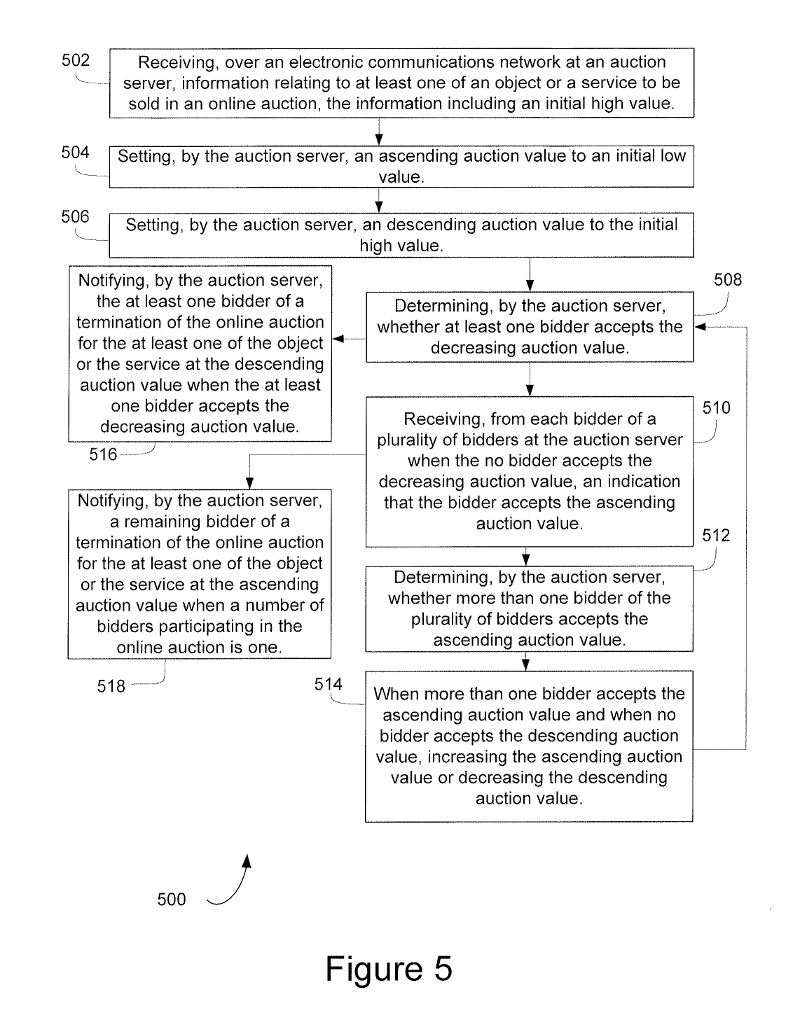

FIG. 5 depicts a flowchart illustrating a method 500 for conducting an online auction using narrowing upper and lower bounds, according to embodiments of the present disclosure. The method 500 for conducting an online auction using narrowing upper and lower bounds may begin at step 502 in which an auction server may receive over an electronic communications network information relating to at least one of an object or a service to be sold in an online auction. The information may include an initial high value of the at least one of the object or service. After receiving information relating to at least one of the object or the service, the method may proceed to step 504 in which the online auction initializes certain online auction values.

At step 504, the auction server may set an ascending auction value to an initial low value. The initial low value may be zero (0) and/or a predetermined low price. The predetermined low price may be automatically determined by a comparison of the object or service for sale to previously sold, similar objects or services. In an alternative embodiment, a seller may set the predetermined low price. In another alternative embodiment, the predetermined low price may be a reserve price, which is a minimum price the object or service may be sold for, or a previous low price, which is an initial low price for a previously sold, similar object or service.

At step 506, the auction server may set a descending auction value to the received initial high value. In one embodiment, a seller of the at least one of the object or service may set the initial high value. Alternatively, the initial high value may be infinity and/or a predetermined high price. The predetermined high price may be automatically determined by a comparison of the object or service for sale to previously sold, similar objects or services. In alternative embodiment, the predetermined high price may be a previous high price, which is an initial high price for a previously sold, similar object or service.

After the online auction initializes certain online auction values, the method may proceed to where the auction server iteratively performs the following steps. The online auction may proceed until a winning bidder is determined when one of two conditions is met. One winning condition may occur when at any time during the online auction a bidder of the plurality of bidders accepts the descending auction value. A second winning condition may occur when at any time during the online auction one bidder remains in the online auction at the ascending auction value.

At step 508, the auction server may determine whether at least one bidder accepts the decreasing auction value. When a bidder accepts the decreasing auction value, the auction server may terminate the iterative performance of steps and/or may terminate the online auction. Further, at step 516, the auction server may notify the at least one bidder of the termination of the online auction for the at least one of the object or the service at the descending auction value when the at least one bidder accepts the decreasing auction value. Otherwise, the auction server may continue to iteratively perform the steps described below.

So long as no bidder accepts the decreasing auction value (i.e., no bidder claims at the decreasing auction value), at step 510, the auction server may receive, from each bidder of a plurality of bidders, an indication that the bidder accepts the ascending auction value. At any point in time, all bidders in the online auction must indicate whether they are willing to purchase the object or service at the ascending auction value. In other words, each bidder may indicate whether they accept the ascending auction value, and thus, may indicate that the bidder wishes to continue participating in the online auction. If a bidder indicates that he or she accepts the ascending auction value, the bidder may purchase the object or service at the descending auction value, as long as the online auction has not ended. If the bidder indicates that he or she does not accept the ascending auction value, he or she may not participate in the online auction any further.

When the number of bidders participating in the online auction is one, the auction server may terminate the iterative performance of steps and/or may terminate the online auction. Further, at step 518, the auction server may notify a remaining bidder of the termination of the online auction for the at least one of the object or the service at the ascending auction value when a number of bidders participating in the online auction is one. Otherwise, the auction server may continue to iteratively perform the steps described below.

At step 514, the auction server may determine whether more than one bidder of the plurality of bidders accepts the ascending auction value. Then at step 516, when more than one bidder accepts the ascending auction value and when the at least one bidder does not accept the descending auction value, the auction server may increase the ascending auction value or decrease the descending auction value. The increasing of the ascending auction value or decreasing of the descending auction value may be adjusted in a variety of manners and rates.

As discussed above, the adjustment of the ascending auction value or the descending auction value may be gradual or discrete. The increasing of the ascending auction value or decreasing of the descending auction value may be based on one or more of the number of bidders participating in the online auction, a current ascending auction value, and a current descending auction value. The ascending auction value may increase by a predetermined increasing price at a predetermined amount of time, the descending auction value may decrease by a predetermined decreasing price at a predetermined amount of time, or both the ascending auction value may increase by a predetermined increasing price at a first predetermined amount of time and the descending auction value may decrease by a predetermined decreasing price at a second predetermined amount of time. Alternatively, the ascending auction value may increase by a predetermined increasing percentage at a predetermined amount of time, the descending auction value may decrease by a predetermined decreasing percentage at a predetermined amount of time, or both the ascending auction value may increase by a predetermined increasing percentage at a first predetermined amount of time and the descending auction value may decrease by a predetermined decreasing percentage at a second predetermined amount of time.

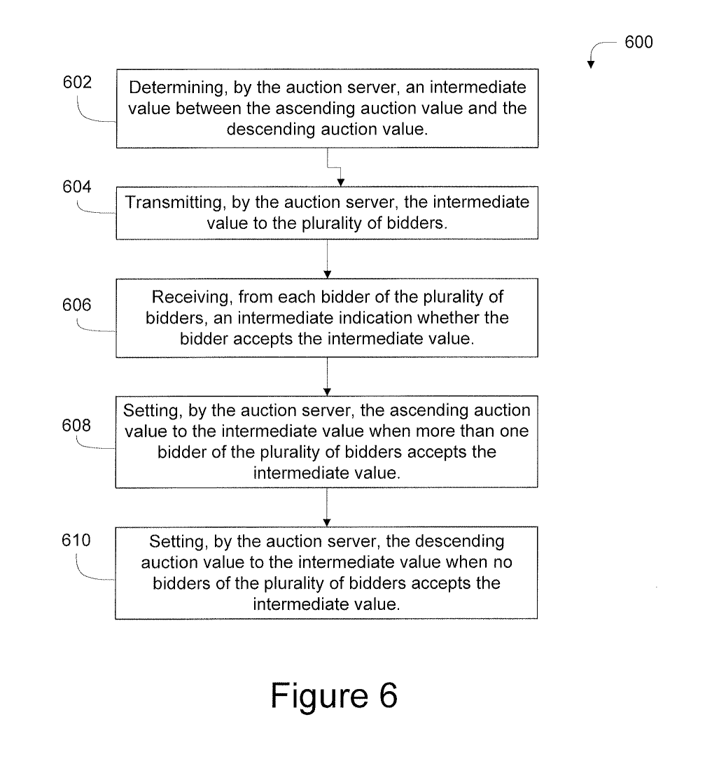

FIG. 6 depicts a flowchart illustrating a method 600 for narrowing upper and lower bounds, according to embodiments of the present disclosure. The method 600 for narrowing upper and lower bounds may begin at step 602. The method 600 may also be used to increasing the ascending auction value or decreasing the descending auction value of the method 500.

At step 602, the auction server may determine an intermediate value between the ascending auction value and the descending auction value. In one embodiment, the intermediate value, which is between the current ascending auction value and the current descending auction value, may be chosen as (i) a value half way between the current ascending auction value and the current descending auction value; (ii) a geometric mean or other mathematical intermediate point of the current ascending auction value and current descending auction value; (iii) based on a number of bidders that accept the ascending auction value; or (iv) based on combination of the above-mentioned methods.

Then at step 604, the auction server may transmit, via the electronic communications network, the intermediate value to the plurality of bidders. Once the intermediate value is provided to the plurality of bidders, the plurality of bidders may be asked whether they accept the intermediate value. At step 606, the auction server may receive, from each bidder of the plurality of bidders via the electronic communications network, an intermediate indication whether the bidder accepts the intermediate value.

When more than one bidder of the plurality of bidders accepts the intermediate value, the auction server at step 608 may set the ascending auction value to the intermediate value. When no bidders of the plurality of bidders accept the intermediate value, the auction server at step 610 may set the descending auction value to the intermediate value. In an alternative embodiment, if one bidder of the plurality of bidders accepts the intermediate value, the one bidder is allocated the good or service at the intermediate value. While a plurality of bidders remains in the online auction, another intermediate value that is between the current ascending auction value and descending auction value may be used, and the method may proceed until only one bidder remains.

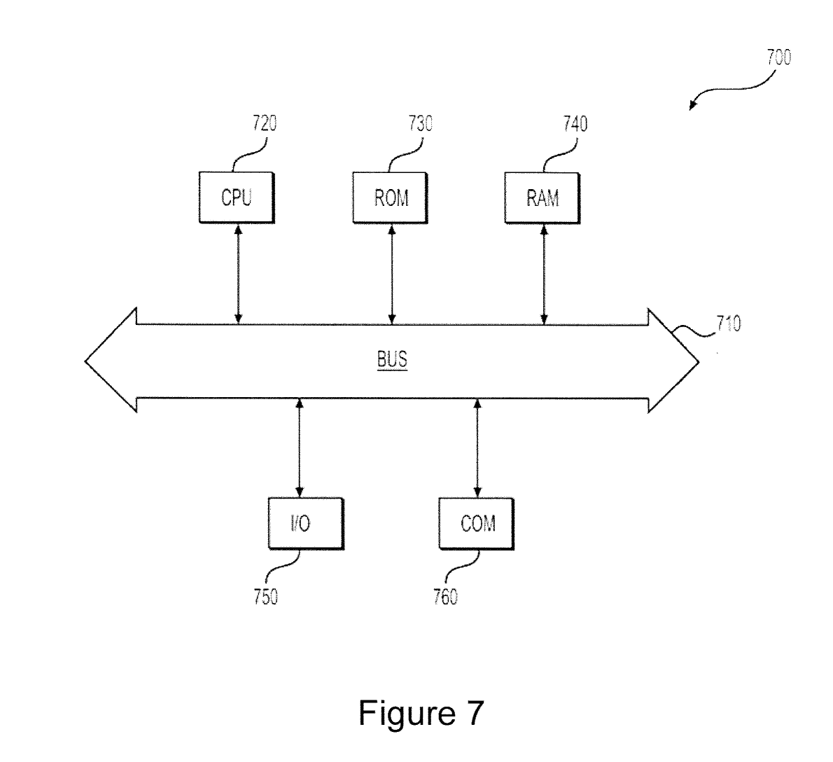

FIG. 7 is a simplified functional block diagram of a computer that may be configured as devices, systems, and/or servers for executing the methods of FIGS. 5 and 6, according to exemplary an embodiment of the present disclosure. Specifically, in one embodiment, any of the devices, systems, and/or servers may be an assembly of hardware 700 including, for example, a data communication interface 760 for packet data communication. The platform may also include a central processing unit (“CPU”) 720, in the form of one or more processors, for executing program instructions. The platform includes an internal communication bus 710, program storage, and data storage for various data files to be processed and/or communicated by the platform, such as ROM 730 and RAM 740, although the system 700 receives programming and data via network communications 760. The server 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical and line networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data within a vehicle, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for conducting an online auction using narrowing upper and lower bounds comprising:
receiving, over an electronic communications network at an auction server, information relating to at least one of an object or a service to be sold in an online auction, the information including an initial high value;
setting, by the auction server, an ascending auction value to an initial low value;
setting, by the auction server, a descending auction value to the initial high value;
iteratively performing, by the auction server, the following steps:
determining, by the auction server, whether at least one bidder accepts the decreasing auction value;
receiving, from each bidder of a plurality of bidders at the auction server when the no bidder accepts the decreasing auction value, an indication that the bidder accepts the ascending auction value;
determining, by the auction server, whether more than one bidder of the plurality of bidders accepts the ascending auction value; and
when more than one bidder accepts the ascending auction value and when no bidder accepts the descending auction value, increasing the ascending auction value or decreasing the descending auction value.

2. The method of claim 1, wherein increasing the ascending auction value or decreasing the descending auction value is based on one or more of the number of bidders participating in the online auction, a current ascending auction value, and a current descending auction value.

3. The method of claim 1, wherein the ascending auction value increases by a predetermined increasing price at a predetermined amount of time

4. The method of claim 1, wherein the descending auction value decrease by a predetermined decreasing price at a predetermined amount of time.

5. The method of claim 1, wherein both the ascending auction value increases by a predetermined increasing price at a first predetermined amount of time and the descending auction value decreases by a predetermined decreasing price at a second predetermined amount of time.

6. The method of claim 1, wherein the ascending auction value increases by a predetermined increasing percentage at a predetermined amount of time

7. The method of claim 1, wherein the descending auction value decrease by a predetermined decreasing percentage at a predetermined amount of time.

8. The method of claim 1, wherein both the ascending auction value increases by a predetermined increasing percentage at a first predetermined amount of time and the descending auction value decreases by a predetermined decreasing percentage at a second predetermined amount of time.

9. The method of claim 1, wherein increasing the ascending auction value or decreasing the descending auction value comprises:
determining, by the auction server, an intermediate value between the ascending auction value and the descending auction value;
transmitting, by the auction server, the intermediate value to the plurality of bidders;
receiving, from each bidder of the plurality of bidders, an intermediate indication whether the bidder accepts the intermediate value;
setting, by the auction server, the ascending auction value to the intermediate value when more than one bidder of the plurality of bidders accepts the intermediate value; and
setting, by the auction server, the descending auction value to the intermediate value when no bidders of the plurality of bidders accepts the intermediate value.

10. The method of claim 9, wherein determining the intermediate value between the ascending auction value and the descending auction value is based on one of: (i) a value half way between the ascending auction value and the descending auction value, (ii) a geometric mean of the ascending auction value and descending auction value, and (iii) a number of bidders that accept the ascending auction value.

11. The method of claim 1, further comprising:
terminating, by the auction server, iteratively performing the steps when the at least one bidder accepts the decreasing auction value; and
notifying, by the auction server, the at least one bidder of a termination of the online auction for the at least one of the object or the service at the descending auction value when the at least one bidder accepts the decreasing auction value.

12. The method of claim 1, further comprising:
terminating, by the auction server, iteratively performing the steps when a number of bidders participating in the online auction is one; and
notifying, by the auction server, a remaining bidder of a termination of the online auction for the at least one of the object or the service at the ascending auction value when the number of bidders participating in the online auction is one.

13. A system for conducting an online auction using narrowing upper and lower bounds, the system including:
a data storage device that stores instructions for conducting an online auction using narrowing upper and lower bounds; and
a processor configured to execute the instructions to perform a method including:
receiving, over an electronic communications network, information relating to at least one of an object or a service to be sold in an online auction, the information including an initial high value;
setting an ascending auction value to an initial low value;
setting a descending auction value to the initial high value;
iteratively performing the following steps:
determining whether at least one bidder accepts the decreasing auction value;
receiving, from each bidder of a plurality of bidders when the no bidder accepts the decreasing auction value, an indication that the bidder accepts the ascending auction value;
determining whether more than one bidder of the plurality of bidders accepts the ascending auction value; and
when more than one bidder accepts the ascending auction value and when no bidder accepts the descending auction value, increasing the ascending auction value or decreasing the descending auction value.

14. The system according to claim 13, wherein increasing the ascending auction value or decreasing the descending auction value is based on one or more of the number of bidders participating in the online auction, a current ascending auction value, and a current descending auction value.

15. The system according to claim 13, wherein increasing the ascending auction value or decreasing the descending auction value comprises:
determining an intermediate value between the ascending auction value and the descending auction value;
transmitting the intermediate value to the plurality of bidders;
receiving, from each bidder of the plurality of bidders, an intermediate indication whether the bidder accepts the intermediate value;
setting the ascending auction value to the intermediate value when more than one bidder of the plurality of bidders accepts the intermediate value; and
setting the descending auction value to the intermediate value when no bidders of the plurality of bidders accepts the intermediate value.

16. The system according to claim 13, wherein determining the intermediate value between the ascending auction value and the descending auction value is based on one of: (i) a value half way between the ascending auction value and the descending auction value, (ii) a geometric mean of the ascending auction value and descending auction value, and (iii) a number of bidders that accept the ascending auction value.

17. The system according to claim 13, further comprising:
terminating iteratively performing the steps when the at least one bidder accepts the decreasing auction value; and
notifying the at least one bidder of a termination of the online auction for the at least one of the object or the service at the descending auction value when the at least one bidder accepts the decreasing auction value.

18. The system according to claim 13, further comprising:
terminating iteratively performing the steps when a number of bidders participating in the online auction is one; and
notifying a remaining bidder of a termination of the online auction for the at least one of the object or the service at the ascending auction value when the number of bidders participating in the online auction is one.

19. A non-transitory computer-readable medium storing instructions that, when executed by a computer, cause the computer to perform a method for conducting an online auction using narrowing upper and lower bounds, the method including:
receiving, over an electronic communications network, information relating to at least one of an object or a service to be sold in an online auction, the information including an initial high value;
setting an ascending auction value to an initial low value;
setting a descending auction value to the initial high value;
iteratively performing the following steps:
determining whether at least one bidder accepts the decreasing auction value;
receiving, from each bidder of a plurality of bidders when the no bidder accepts the decreasing auction value, an indication that the bidder accepts the ascending auction value;
determining whether more than one bidder of the plurality of bidders accepts the ascending auction value; and
when more than one bidder accepts the ascending auction value and when no bidder accepts the descending auction value, increasing the ascending auction value or decreasing the descending auction value.

20. The computer-readable medium of claim 19, wherein increasing the ascending auction value or decreasing the descending auction value is based on one or more of the number of bidders participating in the online auction, a current ascending auction value, and a current descending auction value.
